(19) United States
(12) Patent Application Publication
(10) Pub. No.: US 2008/0203275 A1
(43) Pub. Date: Aug. 28, 2008

(54) Luminaire And Light Sensor For Said Luminaire

(75) Inventor: Paulus Gerardus Henricus Kosters, Winterswijk (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/908,189

(22) PCT Filed: Mar. 14, 2006
(86) PCT No.: PCT/IB06/50784

§ 371 Date: Sep. 10, 2007

(30) Foreign Application Priority Data
Mar. 16, 2005 (EP) 05102051.9

(51) Int. Cl. G01J 1/32

(52) U.S. Cl. 250/205

(57) ABSTRACT

The luminaire accommodates a light-sensor unit (10) adjacent plane P of its light-emission window (2). The light-sensor unit (10) has a light sensor (11) in a box (13) facing an opening (12) therein. The opening (12) is surrounded by a shade (20) which narrows towards the light sensor (11). In axial cross-sections of the shade (20), its inner surface (21) is convex. The shape of the inner surface (21) allows the use of a wide range of materials because the influence of ambient light on the observation of the light sensor (11) is counteracted.

The invention relates to a luminaire comprising:

a housing having a light-emission window in a plane P for emitting light to illuminate a field F opposite the light-emission window;

holding means inside the housing for accommodating an electric lamp L;

a light-sensor unit for controlling the brightness of the electric lamp L, which unit comprises a box accommodating a light sensor facing an opening in said box, the light sensor facing field F and the opening being circumferentially surrounded by a tubular shade adjacent plane P, which shade has an inner surface having a longitudinal axis and which narrows from an outer rim towards the light sensor, and

circuitry for starting and operating the electric lamp L, and for regulating the electric lamp L in dependence upon a signal from the light sensor, which circuitry is electrically connected to the light sensor and the holding means.

The invention also relates to a light-sensor unit comprising a box accommodating a light sensor facing an opening in said box, the opening being circumferentially surrounded by a tubular shade, which shade has an inner surface having a longitudinal axis and which narrows from an outer rim towards the light sensor.

An embodiment of such a luminaire is known from JP-10 30 25 35.

In the known luminaire, the box is present behind a V-shaped reflecting plate between two neighboring tubular lamps. There is an opening in the reflecting plate in which the shade is present. The shade is a separate body having a conical shape. The sensor has for its object to observe the luminance of the illuminated field F and to adjust, by means of a signal to the circuitry, the brightness of the lamp L in dependence upon the desired luminance.

The shade serves to limit the aperture of the sensor, thereby counteracting ambient light, e.g. transmitted by windows, engaging the sensor. When ambient light is allowed to engage the sensor, the observation of the luminance of the field F is inaccurate. In practice, the inner surface of the shade applied in luminaires is black so as to be light-absorbing and thereby to counteract ambient light engaging the sensor after reflection at the inner surface, and thus causing false observations.

It is a disadvantage of the known luminaire that the necessity to prevent reflections restricts the freedom of choosing materials for the shade.

It is a first object of the invention to provide a luminaire of the type described in the opening paragraph, which allows a wide choice of materials for the shade, while nevertheless providing the possibility of a reliable observation of the luminance.

It is a second object of the invention to provide a light-sensor unit of the type described in the opening paragraph, which allows a wide choice of materials for the shade, while nevertheless providing the possibility of a reliable observation of the luminance.

The first object is achieved in that the inner surface of the shade is convex towards said axis in axial cross-sections.

As a result of the shape of the inner surface of the shade, ambient light which could reach the sensor just along the surface of a conical inner surface is now intercepted. Other rays of ambient light, which in a shade having a conical shape would reach the sensor after reflection by the shade, are now reflected outwardly or reach the sensor after multiple reflection, which causes loss of light due to the imperfect reflective properties of almost all materials and thereby diminishes the influence of ambient light. It should be noted that the shape of the shade has some influence on the observation of the luminance of field F, but this effect is much smaller than the favorable effect of counteracting the influence of ambient light.

As a consequence of the shape of the shade, it is no longer necessary that the shade is made of light-absorbing, e.g. dark or black, material. The shade of the luminaire according to the invention may be semi-specularly reflecting or, preferably, diffusely reflecting. It may be, for instance, gray to match esthetically with adjacent metal parts of the luminaire. The box and the shade may be made of e.g. metal, e.g. aluminum, or of plastic, e.g. acrylonitrile butadiene styrene (ABS).

In this connection, it is a favorable consequence of the invention that, in an embodiment, the shade may be integral with the box. This simplifies the manufacture of the light sensor unit and is consequently less costly. As the unit may be made to esthetically harmonize with the luminaire, it can be allowed to be well observable, which provides great freedom of positioning the unit in the luminaire.

Although the convex inner surface of the shade may have a larger screening effect on ambient light, in a favorable embodiment of the luminaire of the invention, the inner surface has such a shape that a tangent to the inner surface goes through the rim, through the axis and through an extreme point of the sensor. A shade of chosen dimensions then provides an effective screening of ambient light, while influencing the observation of the luminance of field F to a small extent only. The tangent may, however, meet the sensor at any other point thereof.

In an embodiment, said tangent meets the sensor in a central area thereof. In this embodiment, there is a balance between obstructing ambient light from reaching the sensor and, nevertheless, a relatively large aperture of the sensor for observing the illumination of field F. Generally, the balance is optimal if the tangent goes through the center of the sensor.

It is favorable if the inner surface in axial cross-sections is curved in accordance with an arc of a circle, although other curvatures, such as e.g. parabolic curvatures are applicable. Alternatively, the inner surface may comprise several conical sections.

The second object of the invention is achieved in that the sensor unit has one or more features as described hereinbefore with reference to the luminaire.

The sensor unit of the invention is suitable for use in a luminaire.

The sensor unit may contain additional sensors, e.g. an infrared detector for receiving a signal to switch the luminaire on and off, and furthermore a motion detector to switch the luminaire off if no motion is detected within a predetermined period of time.

The luminaire of the invention may be intended to accommodate one or more fluorescent lamps, e.g. elongate tubular lamps or lamps having two parallel tubular portions.

The luminaire may contain one or more reflectors for shaping the light generated by a lamp to a beam. Also a e.g. lacquered wall of the housing opposite the light-emission window may constitute a reflector. The luminaire may, however, have a second window opposite the light-emission window so as to also provide indirect lighting.

Lamellae may be present in the light-emission window. Otherwise, the window may be closed by a light-transmitting plate, which is e.g. provided with prisms.

The light sensor may be present in or opposite the light-emission window or alternatively e.g. aside said window in a wall of the housing.

The luminaire may be mounted against, in or below a ceiling, and may be used for illuminating e.g. offices and shops.

An embodiment of the luminaire and the light-sensor unit according to the invention is shown in and explained with reference to the drawings.

In the drawings:

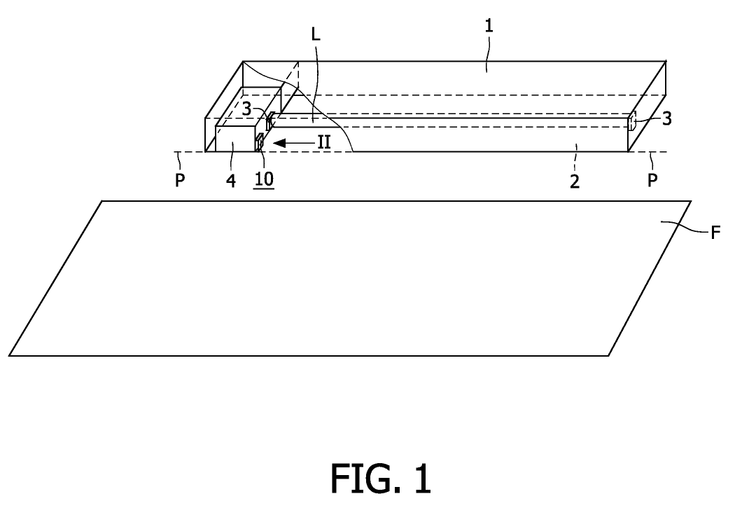

FIG. 1 is a longitudinal cross-section through an embodiment of a luminaire;

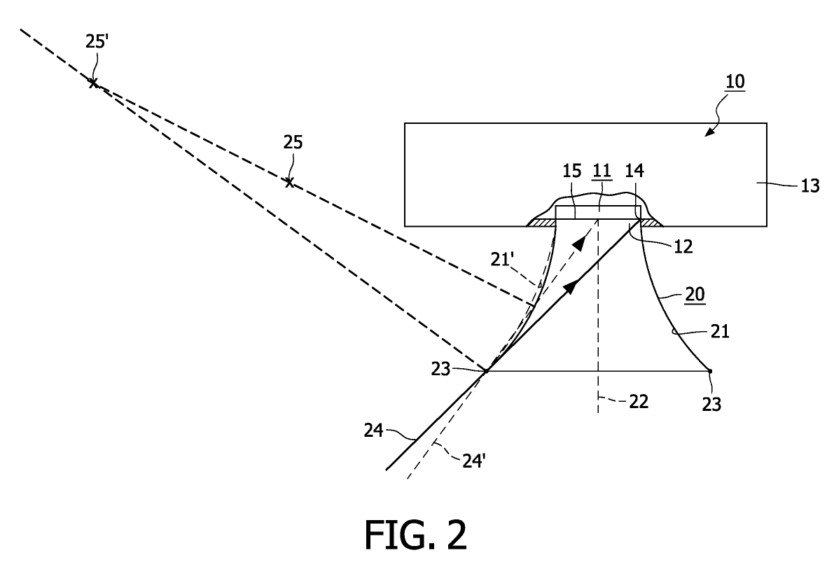

FIG. 2 shows an embodiment of the light-sensor unit of FIG. 1 in a side elevation taken on II in FIG. 1, and partly open, with the shade shown schematically in a cross-section.

In FIG. 1, the luminaire has a housing 1 with a light-emission window 2 in a plane P for emitting light to illuminate a field F opposite the light-emission window 2. Holding means 3 are present inside the housing 1 for accommodating an electric lamp L. The luminaire has a light-sensor unit 10 for controlling the brightness of the electric lamp L. The unit 10, compare FIG. 2, accommodates a light sensor 11 facing an opening 12 in a box 13. The light sensor 11 faces field F and the opening 12 is circumferentially surrounded by a tubular shade 20 adjacent plane P. The shade 20 has an inner surface 21 having a longitudinal axis 22. The shade 20 narrows from an outer rim 23 towards the light sensor 11. Circuitry 4, see FIG. 1, is provided for starting and operating the electric lamp L, and for dipping or raising the light output of the electric lamp L in dependence upon a signal from the light sensor 11. The circuitry 4 is electrically connected to the light sensor 11 and the holding means 3.

The inner surface 21 of the shade 20, see FIG. 2, is convex in axial cross-sections.

In the embodiment shown, the shade 20 is integral with the box 13.

In the Figure, a tangent 24 to the inner surface 21 goes through the outer rim 23, through the longitudinal axis 22 and through an extreme point 14 of the light sensor 11. The inner surface 21 is curved in axial cross-sections in accordance with an arc of a circle. The center of curvature is denoted by reference numeral 25.

FIG. 2 shows another embodiment in dashed lines, in which a tangent 24′ to the inner surface 21 goes through the outer rim 23, through the longitudinal axis 22 and meets the light sensor 11 in a central area 15 thereof, in the Figure in the center of the sensor 12. The shade was made to be gray having a gray value of 0.5. It was experimentally established that, in the embodiment shown, in which the tangent 24′ goes through the center of the light sensor 11, the sensor 11 was a factor of six less sensitive to ambient light than a shade 20 having a conical shape.

1. A luminaire comprising:
a housing (1) having a light-emission window (2) in a plane P for emitting light to illuminate a field F opposite the light-emission window (2);
holding means (3) inside the housing (1) for accommodating an electric lamp L;
a light-sensor unit (10) for controlling the brightness of the electric lamp L, which unit comprises a box (13) accommodating a light sensor (11) facing an opening (12) in said box (13), the light sensor (11) facing field F and the opening (12) being circumferentially surrounded by a tubular shade (20) adjacent plane P, which shade (20) has an inner surface (21) having a longitudinal axis (22) and which narrows from an outer rim (23) towards the light sensor (11), and circuitry (4) for starting and operating the electric lamp L, and for regulating the electric lamp L in dependence upon a signal from the light sensor (11), which circuitry (4) is electrically connected to the light sensor (11) and the holding means (3), characterized in that the inner surface (21) of the shade (20) is convex towards said axis (22) in axial cross-sections.

2. A luminaire as claimed in claim 1, characterized in that the shade (20) is integral with the box (13).

3.A luminaire as claimed in claim 1, characterized in that a tangent (24) to the inner surface (21) goes through the outer rim (23), through the longitudinal axis (22) and through an extreme point (14) of the light sensor (11).

4. A luminaire as claimed in claim 1, characterized in that a tangent (24′) to the inner surface (21) goes through the outer rim (23), through the longitudinal axis (22) and meets the light sensor (11) in a central area (15) thereof.

5. A luminaire as claimed in claim 4, characterized in that the inner surface (21) in axial cross-sections is curved in accordance with an arc of a circle.

6. A light-sensor unit (10) comprising a box (13) accommodating a light sensor (11) facing an opening (12) in said box (13), the opening (12) being circumferentially surrounded by a tubular shade (20), which shade (20) has an inner surface (21) having a longitudinal axis (22) and which narrows from an outer rim (23) towards the light sensor (11),
characterized in that the inner surface (21) of the shade (20) is convex towards the axis (22) in axial cross-sections.

7. A light-sensor unit as claimed in claim 6, characterized in that the shade (20) is integral with the box (13).

8. A light-sensor unit as claimed in claim 6, characterized in that a tangent (24) to the inner surface (21) goes through the outer rim (23), through the longitudinal axis (22) and through an extreme point (14) of the light sensor (11).

9. A light-sensor unit as claimed in claim 6, characterized in that a tangent (24′) to the inner surface (21) goes through the outer rim (23), through the longitudinal axis (22) and meets the light sensor (11) in a central area (15) thereof.

10. A light-sensor unit as claimed in claim 9, characterized in that the inner surface (21) in axial cross-sections is curved in accordance with an arc of a circle.
